(19) United States
(12) Patent Application Publication
(10) Pub. No.: US 2009/0162822 A1
(43) Pub. Date: Jun. 25, 2009

(54) Internet-based mobile learning system and method therefor

(75) Inventors: Daanen T. Strachan, Washington, DC (US); Shaun L. Jones, Baltimore, MD (US)

Correspondence Address: LAWRENCE HARBIN;MCINTYRE HARBIN & KING LLP, 500 9TH STREET, S.E., WASHINGTON, DC, 20003, US

(73) Assignee: m-Lectture, LLC

(21) Appl. No.: 12/292,581

(22) Filed: Nov. 21, 2008

Related U.S. Application Data
(60) Provisional application No. 61/008,563, filed on Dec. 21, 2007.

(51) Int. Cl. G09B 5/00; G06F 7/06; G06F 17/30; H04N 7/173

(52) U.S. Cl. 434/309; 707/3; 725/86; 707/E17.108

(57) ABSTRACT

A mobile learning system and method therefor to provide video-based lectures to PDA devices over a network. To build a database, MIIME type PDA-compatible learning objects are generated from raw files (PowerPoint, MSWord, Macromedia Flash files) of an educator. The system includes a host server to provide an interactive server application to receive and convert raw files to audio/video presentations. Each learning object is classified according to a hierarchal educational structure and converted to a plurality of MIME files that match respective video platforms of a variety of PDA devices. The MIME files are tagged with authorship information, title, and/or other search parameters. A database stores these files on a network storage device for subsequent access by a learner's PDA. The system and method conveniently allow students to use their portable devices as a learning tool, and also enables a wider dissemination of expert instructional material throughout the world.

### CROSS-REFERENCE TO RELATED APPLICATIONS

This invention claims the benefit of U.S. Provisional Application Ser. No. 61/008,563 filed Dec. 21, 2007 entitled “Method of Converting and Publishing Content.”

### BACKGROUND

This invention concerns mobile or distance learning, but more specifically, to a system and method to provide an on-line repository of audio-video lectures to persons desiring knowledge of a particular item of information.

The invention takes advantage of and utilizes recent proliferation of mobile personal digital assistants (PDAs) in schools and universities and uses them as learning tools for students, learners, and other users. As known in the art, the mobile learning community utilizes numerous types of portable devices operating on varying types of I/O and data conversion platforms. Due to the varied communication and conversion platforms, difficulties have arisen in delivering consistent and uniform content to a user or learner. Present day instructional designers, i.e., content developers, have encountered such portable device types as those utilized by the iPod, iPhone, Playstation Portable, Zune, PDAs, Smartphones, mobile DVRs, Tablet PCs, and numerous other devices. At the learner's end of a mobile learning network, parameters impacting rendition of audio, video, or images include video standard(s) adopted, frame repetition rates, audio digitization standards, image size (pixel density), etc. On the content development side, a lack of uniformity in content format has also presented challenges to the instructional designer in preparing certain file formats for video rendition. In addition, prior search and classification schemes for retrieving learning objects from a database have not been specifically designed for providing educationally-structured access to specifically targeted information or to accommodate learning habits of specifically targeted individuals according to conventionally recognized educational or professional levels, thus making them ineffective or difficult to use.

These and other problems have presented an obstacle for achieving effective content development and delivery standards to support mobile learning. Instructional designers are faced with a dilemma of how best to assign taxonomy to instructional content and are also impacted by a lack of a standardized video and/or audio conversion process for mobile devices. Furthermore, the difficulty of creating content without standardization results in an ineffective means for delivering content using conventional software applications as Microsoft Word® and PowerPoint documents, portable document formats (PDF), and hypertext markup language. Since each portable device may use a unique format, e.g., resolution, frames per second, and/or MIME (Multipurpose Internet Mail Extensions) type, creating a method or system for learning object classification, content conversion and/or publishing is exigent and very much needed.

The present invention seeks to overcome these and other shortcomings of the prior art.

### SUMMARY

An embodiment of the present invention enables instructional designers and content developers to convert and publish structurally-classified instructional content (e.g., a fact, concept, procedure, principle, and process) with an assigned content type that can be installed across multiple operating platforms of portable devices. Raw content may include file types of .ppt, .pdf, .html, .xhtml, .doc formats to be converted to a video-based learning object. The instructional designer then determines whether the content is a fact, concept, principle, procedure or process whereupon the learning object is made available to multiple user-learners.

In accordance with a first aspect of the present invention, there is provided an on-demand mobile learning system that includes a repository of video-based learning objects for use by users of a variety of PDA devices over a network. The system enables use of the system by PDA devices of diverse communication platforms and comprises a database to store a plurality of PDA-compatible MIME type files for PDA devices along with associated author information for respective video-based learning objects having an associated classification that indicates (i) an educational skill level, (ii) a knowledge domain associated with a specified skill level, (iii) a topic associated with a specified knowledge domain, and (iv) a category characterizing content of a desired learning object; a web server accessible by the mobile PDA devices to provide an I/O interface application that receives device identification for a PDA device and search parameters supplied by a user according to the classification of a desired learning object; a search engine responsive to the device identification and the search parameters to enable the PDA device to retrieve a compatible MIME type file for a desired video-based learning object; an I/O link to convey the desired video-based learning object over the network from the database to the PDA device of a user whereby to enable the PDA device to render a video presentation of the learning object; and an optional transaction log to record accesses to the learning objects whereby to debit an account of a user and to credit an account of a provider of the learning object.

In accordance with another aspect of the invention there is provided an on-demand mobile learning system including a repository of video-based instructional learning objects authored by an instructional designer. The system comprises a host server that provides an interactive server application to produce over a network a graphical user interface on a computer display device in order to obtain a raw data file from the instructional designer where the raw data file comprises either a slide presentation or a native video presentation; an input window of the user interface to enable the instructional designer to assign search parameters to be used for accessing a video presentation of the raw data file according to a classification scheme that identifies (i) an educational skill level, (ii) a knowledge domain defined by a specified skill level, (iii) a topic associated with a specified knowledge domain, (iv) a category of information indicative of content of said raw data file, and/or (v) a title; a file identification tag to associate the search parameters with the raw data file; a video editor to convert the raw data file to a video presentation; a file converter to convert the video presentation to a plurality of PDA MIME type files for a plurality of respective PDA devices of different video platforms; a database to store, for each raw data file, the plurality of PDA MIME type files, a corresponding file identification tag, and an associated classification whereby to provide a network having a repository of learning objects for subsequent access over a network by a plurality of PDA devices according to respective video platforms thereof; a plurality of mobile PDA devices of diverse communication platforms to access the database; a web server accessible by the mobile PDA devices over the network to provide an I/O interface application that receives device identification for the PDA device and search parameters supplied by a user according to the classification of the a desired learning object; a search engine responsive to the device identification and the search parameters to enable the PDA device to retrieve a compatible MIME type file for a desired video-based learning object; an I/O link to convey the desired video-based learning object over the network from the database to said PDA device of the user whereby to enable the PDA device to render a video presentation of the learning object; and an optional transaction log to record accesses to the learning objects whereby to debit an account of the user and to credit an account of a provider of the learning object.

In accordance with yet another aspect of the invention, there is provided a method of providing and accessing an on-demand mobile learning system that includes a repository of instructional learning objects authored by an instructional designer. The method comprises providing an interactive server application to produce a graphical user interface on a computer display device in order to receive information from an instructional designer; receiving via the user interface a raw data file comprising either a slide presentation or a native video presentation; providing a user interface to enable the instructional designer to assign search parameters to be used for accessing a video presentation of the raw data file according to a classification scheme that identifies (i) an educational skill level, (ii) a knowledge domain defined by a specified skill level, (iii) a topic associated with a specified knowledge domain. (iv) a category of information indicative of content of said raw data file, and (v) a title; converting the raw data file to a video presentation; converting the video presentation to a plurality of PDA MIME type files for a plurality of respective PDA devices of different video platforms; providing a database to store, for each raw data file, the plurality of PDA MIME type files, a corresponding file identification tag, and an associated classification whereby to provide a network having a repository of learning objects for subsequent access over a network by a plurality of PDA devices according to their respective video platforms; enabling a plurality of mobile PDA devices of diverse communication platforms to access the database; providing via a web server an I/O interface application that receives device identification for said PDA device and search parameters supplied by a user according to a classification of a desired learning object; searching the database to retrieve a compatible MIME type file for a desired video-based learning object according to the device identification and the search parameters; conveying the desired video-based learning object over the network from the database to the PDA device of the user whereby to enable the PDA device to render a video presentation of the learning object; and recording a transaction of accesses to the learning objects whereby to debit an account of a user and to credit an account of a provider of the learning object.

These and other aspects and features of the invention will become apparent upon review of the following description taken in connection with the accompanying drawings. The invention, though, is pointed out with particularity by the appended claims.

### BRIEF DESCRIPTION OF THE DRAWINGS

FIG. 1 is a flow diagram of a method of building a repertoire of instructional learning objects according to one aspect of the present invention.

FIG. 2A depicts a display window of a user interface useful to submit a raw data file to server application or to enable a user-learner to obtain a desired learning object from a database.

FIG. 2B shows a classification scheme proposed under a component design theory (CDT) useful to classify or provide search parameters for a learning object.

FIG. 3 is a flow diagram of an alternative method of building a repertoire of instructional learning objects according to a second aspect of the present invention.

FIG. 4 depicts an exemplary mobile learning system that may be used to build a database of learning objects as well as to search and retrieve a desired learning object.

FIG. 5 depicts an illustrative method to build a database and to retrieve a learning object therefrom according to another aspect of the present invention.

FIG. 6 shows a method similar to the method to FIG. 1 but specifying certain of the steps thereof in greater detail.

FIG. 7 is a flow diagram providing further details of the method of FIG. 6 directed to converting a slide presentation of a raw data file.

FIG. 8 is a flow diagram providing further details of the method of FIG. 6 but directed to converting a native video presentation of a raw data file.

### DESCRIPTION OF ILLUSTRATIVE EMBODIMENTS

Except where specified or specifically required, the steps of the method embodiments of the invention are not limited to any specific order.

To produce or develop a database of learning objects, content conversion involves one or more instructional designers (individuals who, using systematic learning methodology and instructional theory, create content for learning) selecting raw content material to be converted. Such raw content material may reside in a format defined by conventional utilities such as Microsoft Word®, PowerPoint (PPT), Portable Document Format (PDF), Hypertext Markup Language (HTML), Macromedia Flash, a vector graphic or other native video file, or any other format used by the instructional designer. The designer may assign or select a taxonomy type to the material before or after converting it to a MIME (Multipurpose Internet Mail Extensions) type file, such as the Joint Photographics Experts Group (JPEG) format, the Graphic Interchange Format (GIF), the Tag Image File Format (TIFF), or any other format established by the Internet community as a MIME type. The selected MIME type file may be further processed by a known method using both a conventional video editor and video converter software to optimize the MIME type file for rendering the learning object on a mobile device, e.g., a PDA, using commercially available file management software, in order to facilitate a student's learning under mobile or stationary circumstances.

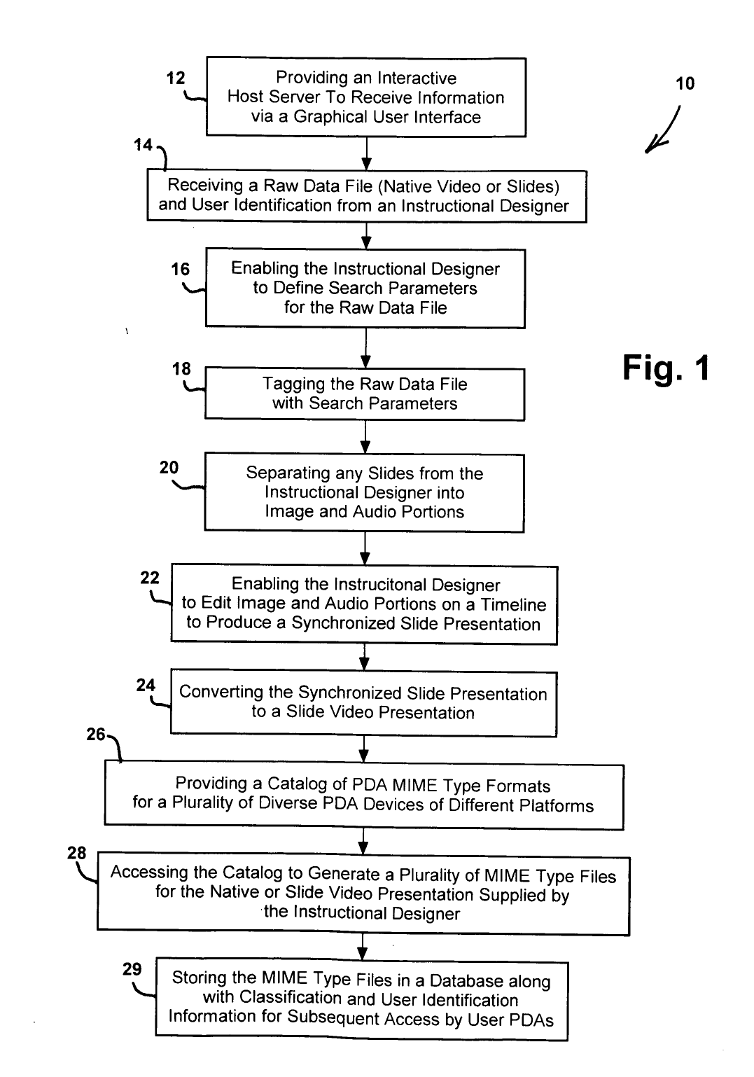

In accordance with a first embodiment of the invention, FIG. 1 illustrates steps of a method 10 that may be practiced to build or develop a repository of instructional learning objects useful to provide mobile learning to a number of user-learners over a wired or wireless network. Nowadays, many learners, such as elementary, middle school, high school, remedial, or college/university students, possess portable PDA devices capable receiving and rendering audio-visual files. In the past, such devices may have been considered disruptive of class and were taken from students but with the aid of the present invention, these devices may now be utilized as a learning tool to facilitate learning.

The illustrative method 10 provides acquisition of learning objects from at least one instructional designer, e.g., an expert, educator or teacher. The method includes a step 12 of providing an interactive server application on a web server to produce a graphical user interface (“GUI”) on a computer display device, e.g., a computer monitor, to receive information from an educator who, at step 14, provides his or her raw data file to a central web server for subsequent processing. The interactive application provided by the host server may receive the raw data file from the educator in the form of a slide or document presentation, e.g., a PowerPoint file, or even a native video file, e.g., a Macromedia Flash video. Other raw data formats may include, but not limited to, a .ppt file, a macromedia file, a vector graphic file, a .swf file, an .html, an .htm file, a .doc, file, and an .flv file. Desired learning objects typically run five to eight minutes in a video display mode of a PDA but are not limited to this period. Limitations imposed are generally restricted by file download rates of a user's PDA device during subsequent use since a user-learner typically has no desire to wait more than a minute or two to receive the learning object.

Most often, the educator will have already prepared and accumulated a repertoire of such learning object files (i.e., instructional lectures) during his or her career and therefore stand ready to replicate the repertoire for instructional learning. Many of these lectures have been successfully proven and tested in effectively conveying educational material and thus provide a valuable resource when readily accessible to students and learners via a wide variety of PDA devices.

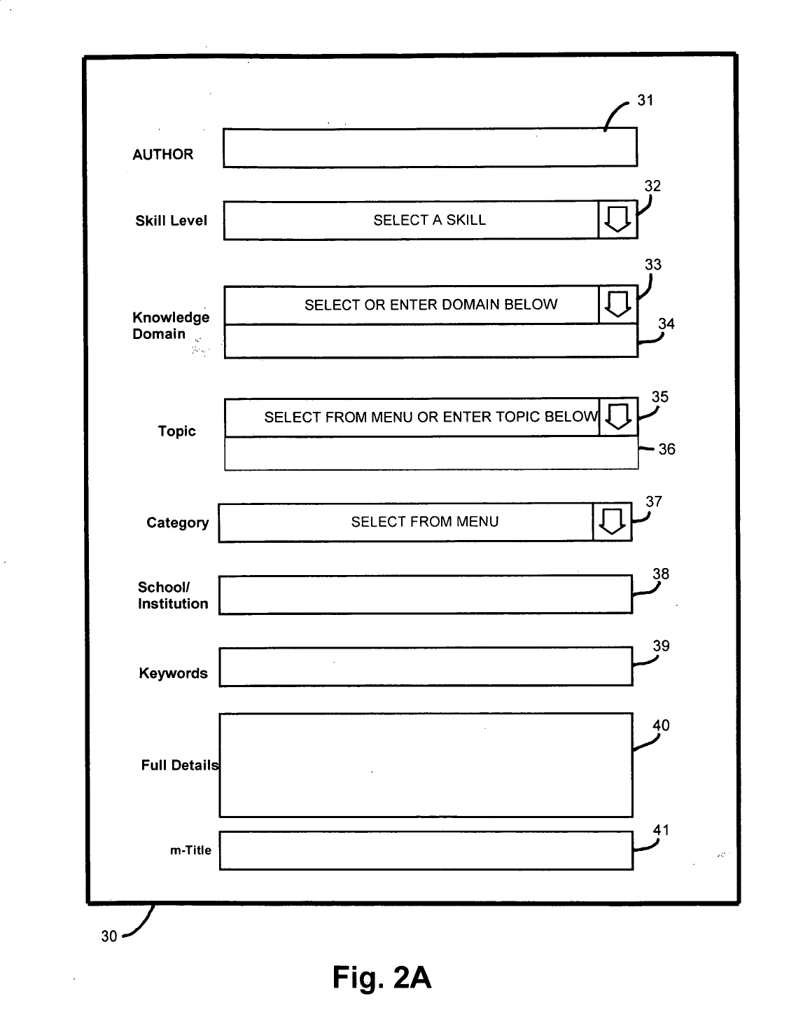

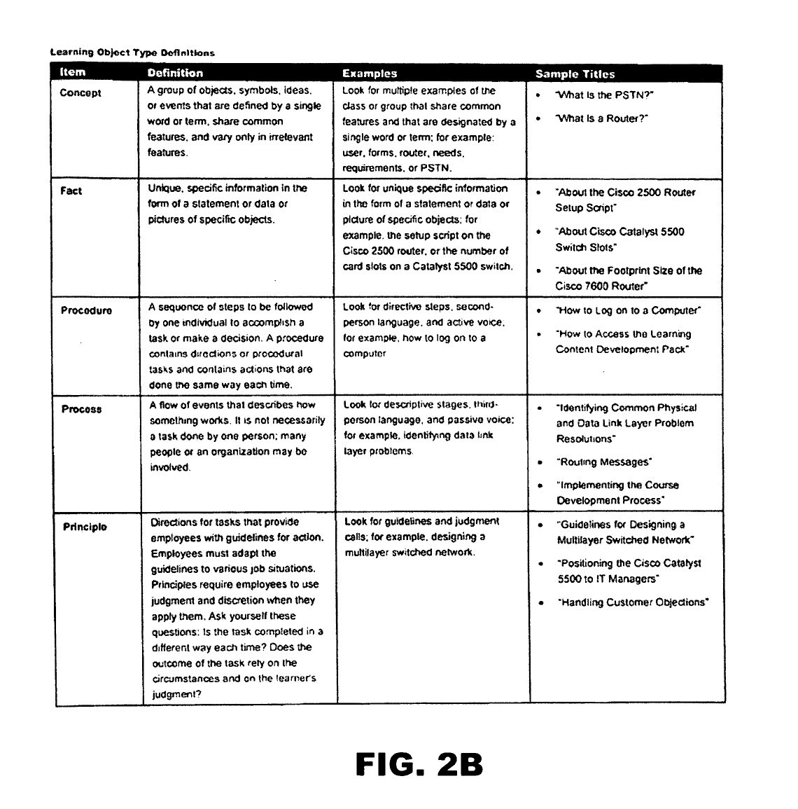

According to his or her expert analysis or assessment, the educator at step 1 6 assigns or selects from a GUI menu the search parameters for the content according to a structurally-designed, proven and effective educational classification scheme, such as that defined by M. D. Merrill, e.g., a fact, concept, principle, process or procedure. FIG. 2B sets forth definitions for such an illustrative classification scheme. Search parameters may also be defined by other schemes as the educator may determine for the subject matter of the learning objects. A learning object title may be included in the list of search parameters. These search parameters form the basis upon which a user-learner may search the learning object database and conveniently locate a desired object for rendering on a PDA device. It should be noted that the step of assigning taxonomy may be performed elsewhere in the overall method 10, as will be appreciated by a person skilled in the art. In addition to selecting or assigning search parameters, the educator provides and the user interface receives user identification information that identifies the educator (e.g., name, address, contact information and/or other information about the instructional designer). Identification information may be used to provide an accounting of use or download of the instructional designer's learning objects by multiple user-learners. Identification information may also denote authorship of the content file as well as accounting data to denote a manner of royalty/commission payment to the instructional designer based on the extent of subsequent use of or access to the educator's learning objects.

Step 18 of method 10 includes enabling the instructional designer to tag or mark via a user interface certain search parameters to be used for accessing a video lecture of the learning object according to a classification scheme. Once the search parameters and/or classification are selected, assigned or determined, the learning object is tagged, marked or associated with this information using conventional techniques. For example, the classification (i.e., search parameters) may be written in a record of the content file or provided in a separate file or memory location and then linked with the content file. Alternatively, search parameters may be linked with corresponding fully processed MIME type files (subsequently described) for use by a search engine (subsequently described) to retrieve and effect rendering of a video presentation of the learning object on a user's PDA device. An illustrative classification may in part identify (i) an educational skill level, (ii) a knowledge domain defined by a specified skill level, (iii) a topic associated with a specified knowledge domain, and (iv) a category of information indicative of content of the learning object according to a well-known and established component design theory (CDT), i.e., concept, fact, principle, procedure, and/or process.

Selections of the educational skill level may include high school, undergraduate, and graduate levels; and selections of the category include fact, concept, principle, procedure, and/or process. The instructional designer may further specify an alternative knowledge domain or an alternative topic. He or she may also specify a particular school, college, or university as an additional identification item of the classification scheme. A lecture title may also be specified as an additional identification item of the classification scheme.

If the raw data file is submitted by the educator to the web application as a native video or vector graphic file, e.g., a Macromedia Flash file, conventional utilities may be employed to convert the raw data file to MIME type files for a range of PDA devices. If, on the other hand, the raw data file is submitted as a series of still images, such as a slide presentation or a document file, e.g., a PowerPoint or MS Word file, the method includes additional step 20 to enable the educator to separate the raw data file into an audio portion and an image portions in order to synchronize any audio with a video portion of the learning object. At step 22, these respective portions or components of the audio and image information are aligned or positioned on a timeline of a video editor in order to “synchronize” a video presentation of the content thereof. Illustrative acts to process a non-video raw data file include (i) separating any slides (or still images) received from the instructional designer via the user interface into an image portion and an audio portion and (ii) enabling the instructional designer to provide timeline for the image portion of the slides or document pages according to the duration of the audio portion thereof. An off-the-shelf commercially-available video editor may be used for these steps. Further, the method may include enabling the instructional designer to create a file, e.g., an .xml file that indicates a start time and an end time for the image portion of each slide. The .xml file may be subsequently parsed to extract information to produce a video of the content having corresponding synchronized audio information. Alternatively, the duration of the image portion may be automatically determined by a duration of the audio portion. The synchronized slide presentation may then be converted to a slide video presentation, as indicated at step 24.

The slide video presentation or the native video presentation of the learning object, whichever the instructional designer provides, is then replicated as a series PDA MIME type files for acceptance and rendering on various types of PDA device platforms. This may be accomplished, at step 26, by providing a catalog of PDA MIME type formats for a plurality of PDA devices having different video platforms and, at step 28, by accessing the catalog to generate the plurality of PDA MIME type files for the native video presentation or the slide video presentation. The catalog of PDA MIME type formats may be based on a hardware device identification associated with respective PDA devices of different video platforms, such as that indicated by the 64-bit IEEE manufacturer's identification code. The PDA MIME type files thus created are then compatible with respective video platforms of the plurality of PDA devices in terms of frames per second (fps), video standard, etc. PDA-compatible file formats include a .wmm, mpeg, wav, etc. to support device/formats as: ZUNE: WMV, MPEG-4, MP4, H.264 video; PSP: MPEG-4; iPOD: MP4, MPEG-4, M4V; PDA/Cell Phone: WMV; and 3-D Hologram: 3D Video.

Thereafter, at step 29, the plurality of PDA MIME type files for each of the respective raw content files submitted by an instructional designer, are stored in a database accessible by the web server with their associated classification and user identification information. These steps may be repeated by a single instructional designer, or practiced by multiple instructional designers in order to accumulate learning objects. The database is also accessible by user-learners during subsequent downloading of learning objects. Accordingly, an Internet repository of learning objects is built or produced for subsequent access by a plurality of PDA devices according to their respective video platforms.

As an additional aspect of the invention, learning objects may automatically be broadcast to specified learners or other users upon creation by an instructional designer. In this instance, the method may further include providing a user list that identifies a number of users to receive the learning object(s), and automatically sending a compatible video presentation of the learning object(s) to PDA devices identified by the user list.

FIG. 2A shows an exemplary search/classification user window 30 of a graphical user interface (“GUI”) that may be used in the method or the apparatus aspect of the invention. Window 30 may be used by the instructional designer to assign taxonomy when submitting a raw data file, or by a user-learner to retrieve a desired learning object from the mobile learning network. Author or user identification information is supplied in field 31 of the user interface 30 and a skill level is selected from the drop-down menu provided by box 32. In the exemplary window 30, selections of drop-down menu may include: General Information, Government, Graduate, High School, Professional, Remedial Education, and Undergraduate. Selections in box 32 control or dictate available selections for the Knowledge Domain of drop-down menu 33. For example, a Graduate selection in box 32 produces conventional university subject selections from “Accounting” to “Zoology” in box 33. Selection of High School in box 32 produces conventional high school domain selections from Algebra to World Geography in box 33. Selection of Remedial Education in box 32 produces selections: ABE, ESL, Math, Science, Reading, and Writing in box 33. As apparent, the search parameters have a hierarchal structure and are specifically designed to enable focused searching in the education and learning community. In addition, a user-defined Knowledge Domain may be entered in box 34, either by an instructional designer or by a user-learner if a particular or unique Knowledge Domain is being sought or defined.

Similarly, selections provided by the Knowledge Domain drop-down menu 34 determine the available selections for Topic drop-down menu 35. Once a Knowledge Domain is selected for box 34, a predetermined list of topics is provided for selections in Topic drop-down menu 35. Using this two-tiered approach, a desired learning object matching the needs or user's search parameters may be efficiently targeted. This type of search or classification scheme may be extended to a three-tiered, or even a four or more-tiered structure. The information sought or classified is further tagged or marked according to a Category selected in box 37, which is a taxonomy defined by the Component Design Theory (CDT), the definitions of which are set forth in the table of FIG. 2B. Also, an instructional designer may specify an alternative Topic in box 36 that is more suitable for the learning object being supplied to the learning object database.

Additional classification or search parameters may include the name of a school or institution, which is entered in box 38. This enables a search to be specifically limited to learning objects created by instructional designers of a particular school or university. Keywords may also be entered in box 39 as an additional search parameters or classification. Box 40 enables entry of full details of a search while box 41 enables entry of a learning object title.

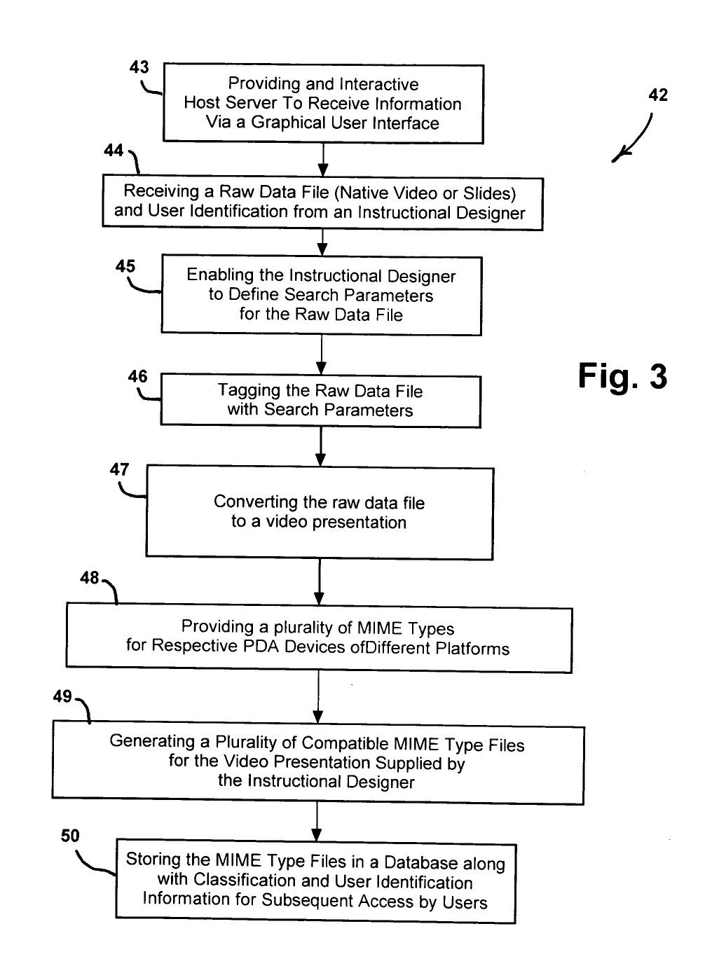

FIG. 3 shows an alternative embodiment of a method 42 according to an aspect of the present invention. Here, the method of building or producing the repository of instructional learning objects includes a step 43 of providing an interactive server application to produce a graphical user interface on a computer display device in order to receive information from an instructional designer; a step 44 of receiving via the user interface a raw data file comprising one of a slide (or a still-image document) presentation and a native video presentation; a step 45 of enabling the instructional designer to assign search parameters to be used for accessing a video presentation of the raw data file according to a classification scheme, such as that previously described herein; a step 46 of tagging/associating/marking the raw data file according to search parameters; a step 47 converting the raw data file to a video presentation; a step 48 of providing a plurality of PDA MIME types for respective ones of a plurality of PDA devices of different video platforms; according to the MIME types, a step 49 of generating a plurality of compatible PDA MIME type files for the video presentation; and a step 50 of storing in a database the plurality of PDA MIME type files and their associated classifications whereby to build a repository of learning objects for subsequent access over a network by a plurality of PDA devices according to their respective video platforms.

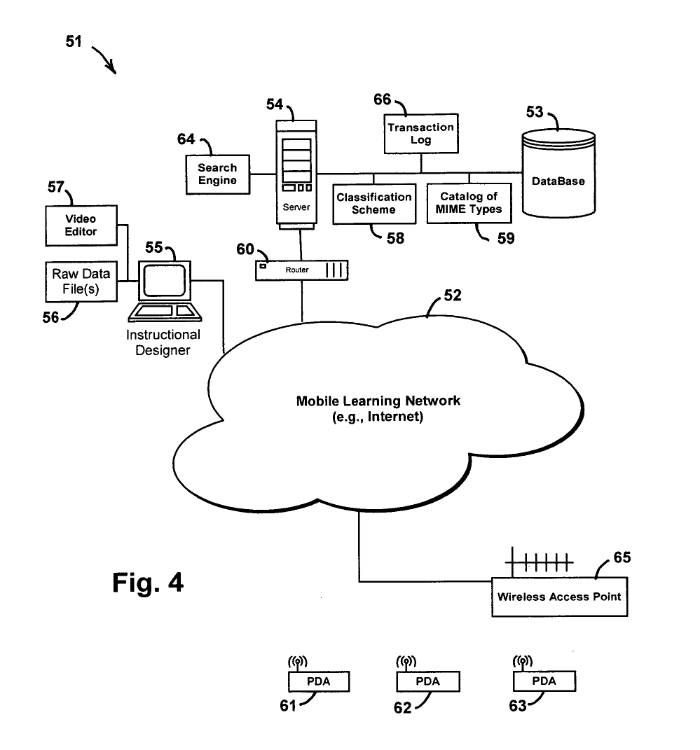

FIG. 4 shows an exemplary mobile learning system 51 to carry out an aspect of the present invention. The apparatus of system 51 comprises a network 52 having a repository, i.e., database 53, of video-based instructional learning objects useful for mobile learning. The apparatus includes a host server 54 in communication with network 52 through a router or switch 60 in order to provide an interactive server application that generates a graphical user interface (e.g., GUI 30 of FIG. 2A) on a computer terminal 55. The computer terminal is used to receive information from an instructional designer stationed thereat. A web application of server 54 receives via the computer terminal 55 a raw data file from the educator's storage 56, which may comprise either a slide (e.g., .ppt, .doc, etc.) presentation or a native video (e.g., macromedia FLASH) presentation. The slide presentation of the educator's lecture typically includes a series of still images and optionally, an associated audio track. The native video presentation typically includes a frame rate video rendition (e.g., 15 or 30 frames per second) with an associated audio track.

An input window of the user interface enables the instructional designer to assign search parameters to be used for accessing a video presentation of the lecture content according to a classification defined by module 58, as previously explained. A conventional video editor 57 (which may include format translation routines) of work station 55 enables the instructional designer to separate and synchronize audio and video portions of a slide presentation, as well as to convert the video presentation to a plurality of PDA MIME type files for a plurality of respective PDA devices of different video platforms identified by a catalog 59 of MIME types. The video editor may be provided locally by the work station 55, or via a web application provided by the server 54. The database 53 is provided to store, for each raw data file, a plurality of PDA MIME type files, a corresponding file identification tag, and/or an associated classification whereby to provide a network having a repository of learning objects for subsequent access over a network by a plurality of PDA devices according to their respective video platforms.

Users or learners possessing PDA devices 61, 62, 63 may access video-based learning objects from database 53 via a user interface 30 (FIG. 2A) by entering search parameters or other information, as previously explained. These search parameters are processed by search engine 64 according to user inputs in order to retrieve a desired learning object from the database 53 via the network 52 and wireless access point 65. Accesses and downloads of learning objects are optionally registered or recorded by a transaction log module 66 for subsequent use in accounting, as previously explained. Instead of using a portable PDA device, a user-learner may also access learning object via a wired link to network 52.

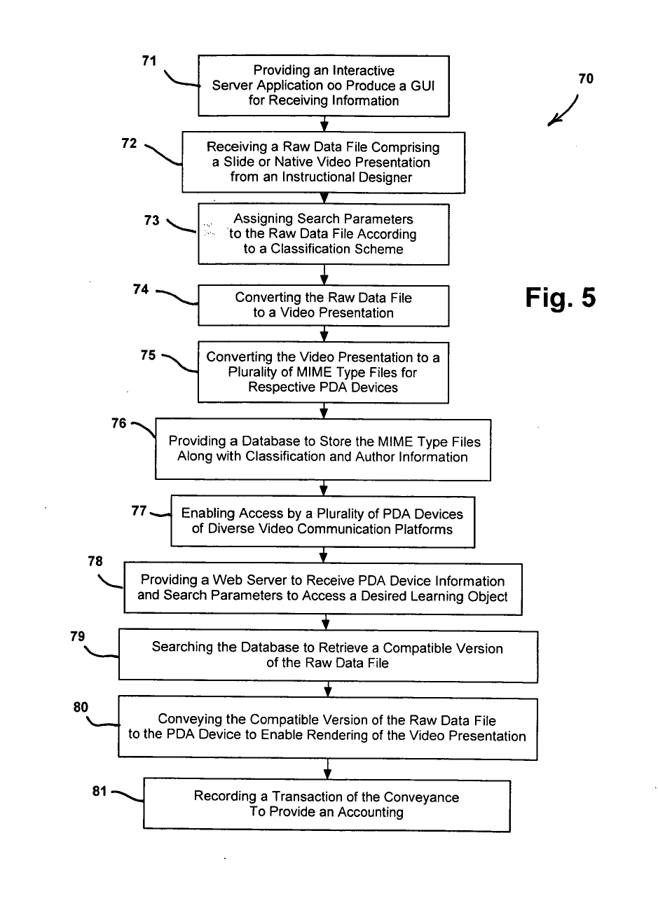

FIG. 5 illustrates a method 70 of providing and accessing an on-demand mobile learning network that includes a repository of instructional learning objects authored by an instructional designer according to yet another aspect of the present invention. The illustrative method 70 includes providing 71 an interactive server application via a web server to produce a graphical user interface on a computer display device in order to receive information from an instructional designer; receiving 72 via the user interface a raw data file from the instructional designer comprising either a slide/document presentation or a native video presentation; assigning 73 via a user interface search parameters (e.g. a learning object classification) to be subsequently used for accessing a video presentation of the raw data file according to a classification scheme, as previously explained herein; converting 74 the raw data file to a video presentation, which may be accomplished using commercially available video editors; converting 75 the video presentation to a plurality of PDA MIME type files for a plurality of respective PDA devices of different video platforms, as previously explained herein; providing 76 a database to store, for each raw data file, the plurality of PDA MIME type files for the raw data file, a corresponding file identification tag, and/or an associated classification whereby to provide a network having a repository of learning objects for subsequent access over a network by a plurality of PDA devices according to their respective video platforms; enabling 77 a plurality of mobile PDA devices of diverse communication platforms to access said database; providing 78 via a web server an I/O interface application that receives device identification for the PDA devices and search parameters supplied by a user according to the classification of a desired learning object; searching 79 the database to retrieve a compatible MIME type file for a desired video-based learning object according to a PDA device identification and the search parameters obtained via the user's PDA device; conveying 80 the desired video-based learning object over the network from the database to the user's PDA device whereby to enable the PDA device to render a video presentation of the learning object; and optionally recording 81 a transaction of accesses to the learning objects whereby to debit an account of a user and to credit an account of an instructional designer who authored the learning object. This latter step 81 is performed when an accounting is to be made but, in certain instances, learning object may be freely provided to learners within a community or campus environment.

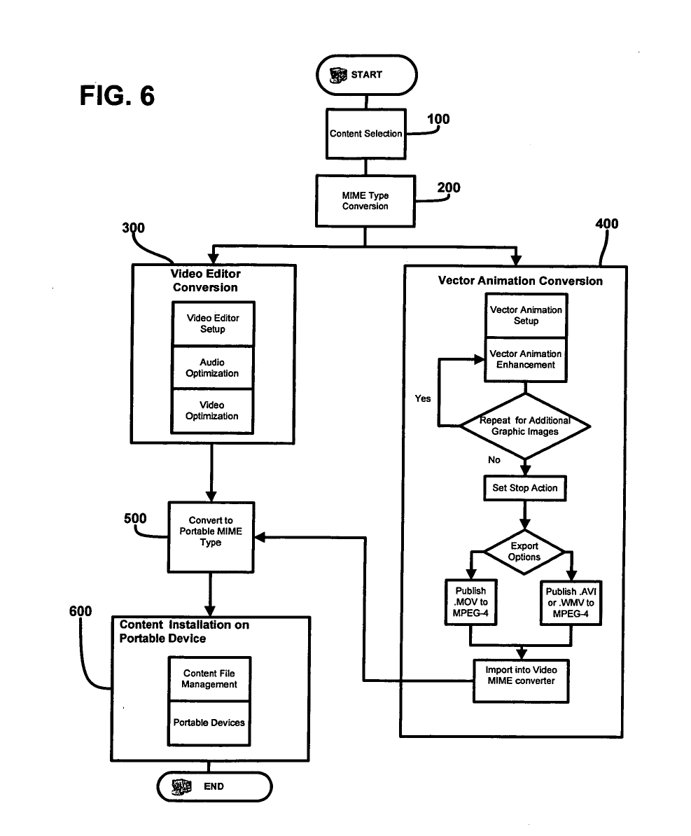

FIGS. 6, 7 and 8 illustrate one of many practicable implementations of the invention. To illustrate a high level of description, FIG. 6 shows a process commencing at step 100 where an instructional designer selects a content file from storage residing in one of the many previously-explained formats to produce a video-based learning object. At step 200, the content file is converted to a MIME type format for convenient video processing, editing, and conversion by commercially-available image or video editing software applications. As previously explained, a raw content file of an instructional designer may reside in memory file as a series of still images or slides (e.g., PowerPoint, MSWord file, etc.) or as a native video file (e.g., Macromedia Flash, .mov, .mpeg, etc.) The initial format of raw content determines whether further processes occurs through video editing conversion step 300 for slides or through vector animation conversion step 400 for native video files. Details of steps 300 and 400 are subsequently explained. After completing one of steps 300 or 400, the resulting converted video file (i.e., lecture) for either of these steps is converted at step 500 to a series of MIME type files to match compatibilities of respective PDA platforms. In this particular embodiment, a taxonomy classification is assigned to the files at step 600 to enable the mobile PDA devices to search and retrieve a desired lecture.

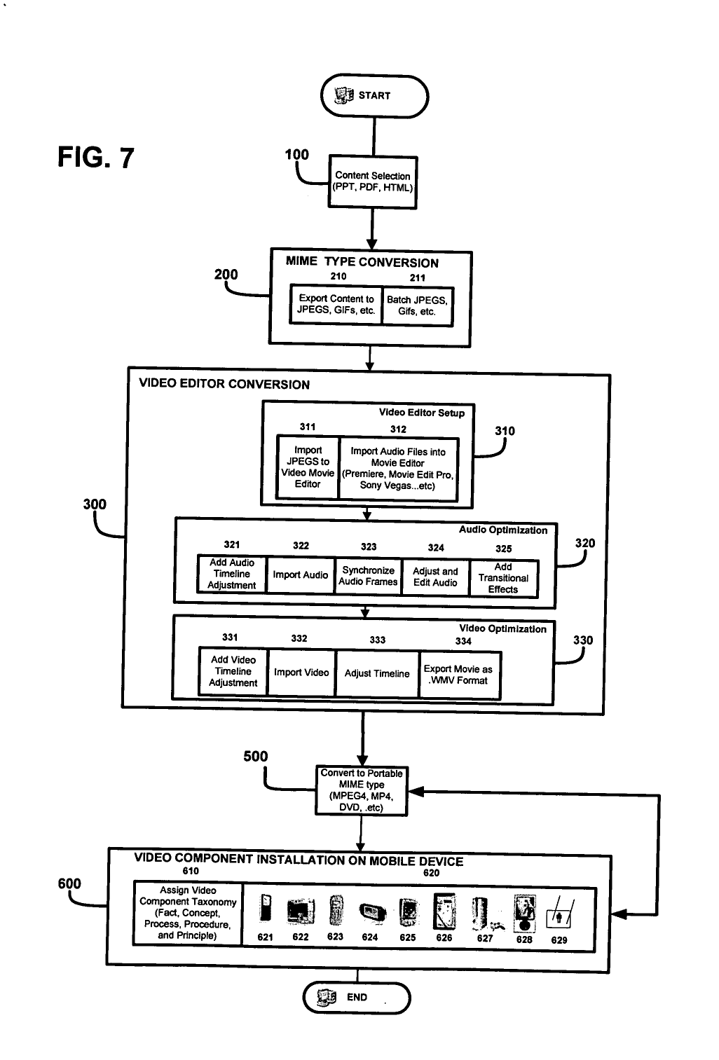

FIG. 7, wherein like reference numerals show like processing steps, further illustrates creation of compatible MIME type file originating from slide or still image content, such as a PowerPoint, PDF, HTML or MSWord file. Raw content selection occurs at step 100. MIME type conversion step 200 includes exporting 210 images of the raw slides to a JPEG, GIF, or other formats as well as importing 211 additional JPEG, GIF, or other images into the lecture. When raw slides are converted to standard MIME type files, they are more readily edited and converted by conventional video editing applications. Next, video editing step 300 includes a video editing step 310 comprising importing 311 the JPEG/GIF images into a video movie editor and importing 312 any additional audio and image files into the movie editor. Exemplary commercially-available movie editors include Adobe Premiere, Movie Editor Pro, Sony Vegas, and others. Next, an audio optimization step 320 comprises a step 321 of adjusting/inserting an audio timeline in the video editor, a step 322 of importing audio information to the timeline, a step 323 of synchronizing the audio frame, a step 324 of adjusting and editing the audio timeline, and a step 325 of adding transitional effects between images, if desired. Any one or more of the steps 320-325 may be omitted, re-arranged, or expanded as appropriate or desired. In a video optimization step 330, the video editor is selected or activated at step 331, the video export resolution is adjusted at step 332, the resolution and framework for the mobile device(s) is selected at step 333, and the movie is exported as an MPEG file at step 334. Similarly, any one or more of the steps 330-334 may be omitted, re-arranged, or expanded as appropriate or desired. At step 500, the MPEG file is converted to respective MIME type files, such as MPEG4, MP4, DVD, etc. that match the compatibility of respective PDA devices. A following step 600 includes a user selecting/assigning 610 a component taxonomy (i.e., search parameters) to download and render a compatible MIME type file of the lecture on one of many portable PDA devices 620-626.

A PPT file upload and conversion process may include uploading content and file metadata to a web application, which submits a package of byte streams of all files uploaded from a temporary file repository to a web server. MIME Type Snapshot Images are extracted using, for example, a Microsoft Office Interop assembly available at http://msdn.microsoft.com/en-us/library/aa159923.aspx. The Interop assembly opens the PowerPoint file. Using the “Save As PNG Image” command, the PowerPoint file is saved as a series of PNG images corresponding to each slide in the PowerPoint slideshow. Next, slide duration or timing information is extracted from an XML file created by the instructional designer. This is accomplished by the web server parsing the XML document to extract timing information to define a start and end timeframe for slides to be presented in the final rendered video. This allows for a dynamic slideshow flow instead of a static time otherwise assigned to each slide frame. The endstate of this step is that the WS becomes aware programmatically of the time assigned to each slide snapshot.

As sample XML file defining slide timing is show below:

<mContent>
<numPages>14</numPages>
<audioPage>
<startFrame>00:00:00</startFrame>
<endFrame>00:00:07</endFrame>
</audioPage>

The process may include adjusting the display time intervals for snapshot images and also adjusting number of stills to the timeframe intervals by calculating number of frames from slide to slide. The interval duration or display time for each slide (extracted from the XML file) is used to multiply snapshots during time intervals. This algorithm takes the frames-per-second of a pending final video and generates a frame for each frame per second for that slide's duration from the previous step, i.e., frames-per-second multiplied by the IntervalDuration=Number of Frames. Next, image frames are created to generate video pre-processed frames from slide snapshots by using the previous step to calculate the number of frames and multiply the slide snapshot as many times as necessary to create video frames. The content is then uploaded with its metadata/tag whereupon the web application receives a file upload byte stream from the client web browser. The submission is rendered by the web application submitting a package of byte streams of all files uploaded from the web application temporary file repository to the web server. A MIME type is assigned using a commercially-available video conversion FFMPEG application available at http://ffmpeg.mplayerhq.hu/. The following arguments may be used to convert the PowerPoint audio and video to device and portable video formats:

Ipod / Iphone
sb.Append(ffArgs(outVideo, vidCodec.xvid, “-f mp4 -vcodec
libxvid -maxrate 2500000 -qmin 3-qmax 5 -bufsize 4096
-g 300 -acodec libfaac -s 320×240 -ab 128000 -b 180000”));
SmartPhone:
sb.Append(ffArgs(outVideo, vidCodec.wmv1,
“-acodec wmav1 -r 24 -s qvga”));
Zune:
sb.Append(ffArgs(outVideo, vidCodec.wmv2, “-acodec wmav2
-s 320×240 -b 640000 -maxrate 1350000 -bufsize 2048000
-ab 128000 -ac 2”));
PSP_Vid:
sb.Append(ffArgs(outVideo, vidCodec.NULL, “-f psp -r 29.97
-b 768k -ar 24000 -ab 64k -s 320×240”));
PSP_Thumb:
sb.Append(ffArgs(outVideo, vidCodec.NULL, “-f image2 -ss 5
-vframes 1 -s 160×120 -an

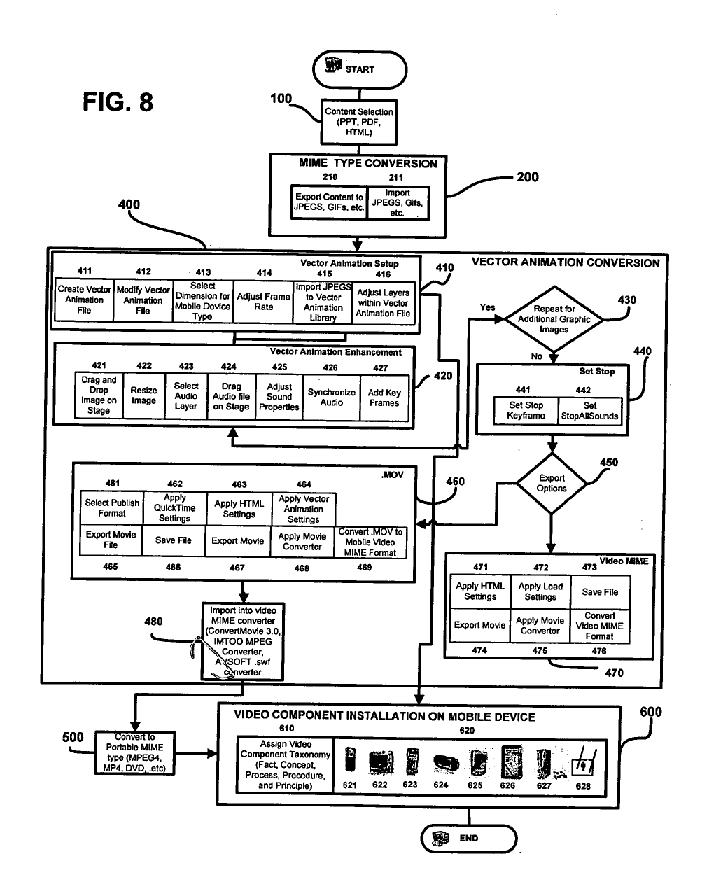

FIG. 8, wherein like reference numerals show like processing steps, illustrates creation of compatible MIME type file originating from a native video lecture (e.g., a Macromedia Flash presentation) submitted to the web server by an instructional designer. The processing steps of steps 100, 200, 500, and 600 may remain the same as discussed relative to FIG. 7, but processing in vector animation conversion block 400 differs.

Conversion block 400 includes vector animation setup procedure 410 comprising obtaining or creating 411 a vector animation file for video processing or enhancement, modifying 412 the vector animation file according to the instructional designer's desire, adjusting 413 a frame rate of the vector animation file for the desired PDA device(s), selecting 414 pixel or display dimensions for the desired PDA device, importing 415 JPEGs to/from a vector animation library, and adjusting 416 layers within the vector animation file. Next, a vector animation enhancement step 420 may comprise dragging and dropping 421 images on a staging area, resizing 422 any images, selecting 423 an audio layer, dragging 424 an audio file to staging area, adjusting 425 sound properties, synchronizing 426 audio with video, and adding 427 key frames that facility video playback. These steps 410 and 420 are repeated at step 430 for additional graphic images. Thereafter, keyframes are set at step 400 by setting 441 a stop keyframe and setting 442 a stopsound.

Export options are considered at step 450 where .mov file processing flows towards step 460 and .wma (.avi) files processing flows towards step 470. Process step 460 may comprise selecting 461 a publishing format, applying 462 QuickTime settings, applying 463 HTML settings, applying 464 vector animation settings, exporting 465 the movie file, saving 466 the movie file in memory storage, exporting 467 the moving file, applying 468 a movie converter, and converting 469 the movie file to an MPEG4 format. Process step 470 may include applying 471 any HTML settings, applying 472 any load settings, saving 473 the file, exporting 474 the movie file, applying 475 the movie converter, and converting 476 the AVI file to an MPEG4 format. The resulting file of either step 460 or 470 is then applied to a process 480 of importing the movie file into a MIME converter (e.g., commercially-available software applications such as ConvertMovie 3.0, IMTCO MPEG Converter, AVSOFT swf converter). Thereafter, the resulting movie file passes to steps 500 and 600, as previously explained. File size dimension is 320×240 pixels with a frame rate of 29.97 fps for an iPod; min 640×480 pixels with a frame rate of 29.97 fps for a PocketDish; and according to the unit's minimum resolution dimensions for Pocket PCs, mobile phones and other devices.

The scope of the invention is not limited to the illustrative embodiments shown or described herein. Based on the teachings hereof, variations may readily come to be known by those skilled in the art without departing from the spirit and intent of the invention. For example, the database is shown to reside on a network but all or a condensed version thereof may reside elsewhere in the system or may very well be transmitted over the network to respective PDA devices for local use and access. The network may be private or public. A PDA device may also send learning objects to the database. Raw data files may be created on-the-fly or may reside in memory storage of an instructional designer in any format. The number and nature of MIME type formats will likely grow or become altered over time, and thus the invention is not limited to the specific formats specified herein. Classification schemes and search parameters may also take on various other forms and thus the invention is not limited to the characterization or number of parameters specified herein. Accordingly, the invention is defined by the appended claims rather than by the above disclosure of illustrative embodiments.

We claim:

1. An on-demand mobile learning system that includes a repository of video-based learning objects provided by at least one instructional designer, said system being accessible over a network by a plurality of mobile PDA devices of diverse communication platforms and comprising:
(a) a database to store a plurality of PDA-compatible MIME type files for said PDA devices along with associated author information for respective ones of said video-based learning objects, each of said learning objects having an associated classification that indicates:
(i) an educational skill level,
(ii) a knowledge domain associated with a specified skill level,
(iii) a topic associated with a specified knowledge domain, and
(iv) a category characterizing content of a desired learning object;
(b) a web server accessible by said mobile PDA devices to provide an I/O interface application that receives device identification for a PDA device and search parameters supplied by a user according to said classification of a desired learning object;
(e) a search engine responsive to the device identification and the search parameters to enable the PDA device to retrieve a compatible MIME type file for said desired video-based learning object;
(f) an I/O link to convey the desired video-based learning object over the network from said database to said PDA device of said user whereby to enable the PDA device to render a video presentation of said learning object; and
(h) a transaction log to record accesses to said learning objects whereby to debit an account of said user and to credit an account of a provider of said learning object.

2. The on-demand mobile learning system of claim 1, wherein the plurality of PDA-compatible MIME type files for respective ones of said video-based learning objects support device-format combinations as ZUNE: WMV, MPEG-4, MP4, H.264 video; PSP: MPEG-4; iPOD: MP4, MPEG-4, M4V; PDA/Cell Phones: WMV; and 3-D Hologram: 3D Video.

3. The on-demand mobile learning system of claim 2, wherein the classification scheme of the I/O interface provides selections of an educational skill level that includes high school, undergraduate, and graduate levels; and provides selections of a category that includes fact, concept, principle, procedure, and process.

4. The on-demand mobile learning system of claim 3, wherein said I/O interface enables the user to specify an alternative knowledge domain or an alternative topic.

5. The on-demand mobile learning system of claim 4, wherein said I/O interface enables the user to specify a particular school, college, or university as an additional identification item of said classification scheme.

6. The on-demand mobile learning system of claim 4, wherein said I/O interface enables the user to specify to specify a title as an additional identification item of said classification scheme.

7. The on-demand mobile learning system of claim 3, wherein said user interface further includes a keyword search function to enable the search engine to retrieve a result.

8. An on-demand mobile learning system including a repository of video-based instructional learning objects authored by an instructional designer, said system comprising:
(a) a host server that provides an interactive server application to produce over a network a graphical user interface on a computer display device in order to obtain a raw data file from said instructional designer, said raw data file comprising one of a slide presentation and a native video presentation;
(b) an input window of said user interface to enable the instructional designer to assign search parameters to be used for accessing a video presentation of said raw data file according to a classification scheme that identifies:
(i) an educational skill level,
(ii) a knowledge domain defined by a specified skill level,
(iii) a topic associated with a specified knowledge domain,
(iv) a category of information indicative of content of said raw data file; and
(v) a title;
(c) a file identification tag to associate said search parameters with said raw data file;
(d) a video editor to convert the raw data file to a video presentation;
(e) a file converter to convert the video presentation to a plurality of PDA MIME type files for a plurality of respective PDA devices of different video platforms;
(f) a database to store, for each raw data file, the plurality of PDA MIME type files, a corresponding file identification tag, and an associated classification whereby to provide a network having a repository of learning objects for subsequent access over a network by a plurality of PDA devices according to respective video platforms thereof;
(g) a plurality of mobile PDA devices of diverse communication platforms to access said database;
(h) a web server accessible by said mobile PDA devices over the network to provide an I/O interface application that receives device identification for said PDA device and search parameters supplied by a user according to said classification of said a desired learning object;
(i) a search engine responsive to the device identification and the search parameters to enable the PDA device to retrieve a compatible MIME type file for a desired video-based learning object;
(j) an I/O link to convey the desired video-based learning object over the network from said database to said PDA device of said user whereby to enable the PDA device to render a video presentation of said learning object; and
(k) a transaction log to record accesses to said learning objects whereby to debit an account of said user and to credit an account of a provider of the learning object.

9. A method of providing and accessing an on-demand mobile learning system that includes a repository of instructional learning objects authored by an instructional designer, said method comprising:
(a) providing an interactive server application to produce a graphical user interface on a computer display device in order to receive information from said instructional designer;
(b) receiving via said user interface a raw data file comprising one of a slide presentation and a native video presentation;
(c) providing a user interface to enable the instructional designer to assign search parameters to be used for accessing a video presentation of said raw data file according to a classification scheme that identifies:
(i) an educational skill level,
(ii) a knowledge domain defined by a specified skill level,
(iii) a topic associated with a specified knowledge domain,
(iv) a category of information indicative of content of said raw data file; and
(v) a title;
(d) converting the raw data file to a video presentation;
(e) converting the video presentation to a plurality of PDA MIME type files for a plurality of respective PDA devices of different video platforms;
(f) providing a database to store, for each raw data file, the plurality of PDA MIME type files, a corresponding file identification tag, and an associated classification whereby to provide a network having a repository of learning objects for subsequent access over a network by a plurality of PDA devices according to their respective video platforms;
(g) enabling a plurality of mobile PDA devices of diverse communication platforms to access said database;
(h) providing via a web server an I/O interface application that receives device identification for said PDA device and search parameters supplied by a user according to a classification of a desired learning object;
(i) searching the database to retrieve a compatible MIME type file for a desired video-based learning object according to the device identification and the search parameters;
(j) conveying the desired video-based learning object over the network from said database to said PDA device of said user whereby to enable the PDA device to render a video presentation of said learning object; and
(k) recording a transaction of accesses to said learning objects whereby to debit an account of said user and to credit an account of a provider of the learning object.

10. The method of claim 9, wherein said raw data file supplied by said instructional designer comprises one of a .ppt file, a macromedia file, a vector graphic file, a .swf file, an .html, an .htm file, a .doc, file, and an .flv file.

11. The method of claim 10, wherein the MIME type of said video presentation supports device-format combinations as ZUNE: WMV, MPEG-4, MP4, H.264 video; PSP: MPEG-4; iPOD: MP4, MPEG-4, M4V; PDA/Cell Phones: WMV; and 3-D Hologram: 3D Video.

12. The method of claim 11 wherein, in said providing step (c), selections of said standard educational skill level include high school, undergraduate, and graduate levels; and selections of said category include fact, concept, principle, procedure, and process.

13. The method of claim 11 further including, in said providing step (c), enabling the instructional designer to specify an alternative knowledge domain or an alternative topic.

14. The method of claim 11, wherein in said providing step (a), said host server is provided on an interactive Internet web server.

15. The method of claim 11, wherein said converting step (d) is performed using a standard video editor.
